(19) United States
(12) Patent Application Publication
(10) Pub. No.: US 2026/0073837 A1
(43) Pub. Date: Mar. 12, 2026

(54) DISPLAY APPARATUS AND METHOD OF OPERATING THE SAME

(71) Applicant: SAMSUNG ELECTRONICS CO., LTD., Suwon-si (KR)

(72) Inventors: Donghyun SEO, Suwon-si (KR); Jeongheon KIM, Suwon-si (KR); Kijune BAEK, Suwon-si (KR); Kwangyoung OH, Suwon-si (KR); Simyoung OH, Suwon-si (KR)

(73) Assignee: SAMSUNG ELECTRONICS CO., LTD., Suwon-si (KR)

(21) Appl. No.: 19/323,496

(22) Filed: Sep. 9, 2025

Related U.S. Application Data
(63) Continuation of application No. PCT/KR2025/012927, filed on Aug. 25, 2025.

(30) Foreign Application Priority Data
Sep. 9, 2024 (KR) 10-2024-0122579

(51) Int. Cl. G09G 3/20; G06F 3/147

(52) U.S. Cl. CPC G09G 3/2096; G06F 3/147; G09G 2330/021; G09G 2330/06; G09G 2340/0435

(57) ABSTRACT

A display apparatus, including: transmission circuitry; reception circuitry; a transmission/reception interface configured to connect the reception circuitry to the transmission circuitry; at least one processor; and memory configured to store instructions which, when executed by the at least one processor, individually or collectively, cause the display apparatus to: detect a frame rate of an input image; adjust a clock parameter of a clock signal based on the detected frame rate to generate an adjusted clock signal; and transmit a data signal generated based on the adjusted clock signal and image data corresponding to the input image, from the transmission circuitry to the reception circuitry using the transmission/reception interface

### CROSS-REFERENCE TO RELATED APPLICATIONS

This application is a continuation of International Application No. PCT/KR2025/012927, filed on Aug. 25, 2025, in the Korean Intellectual Property Receiving Office, which is based on and claims priority to Korean Patent Application No. 10-2024-0122579 filed on Sep. 9, 2024, in the Korean Intellectual Property Office, the disclosures of which are incorporated by reference herein in their entireties.

### BACKGROUND

### 1. Field

The disclosure relates to a display apparatus and a method of operating the display apparatus, and more particularly, to a display apparatus in which a clock signal is varied and a method of operating the display apparatus.

### 2. Description of Related Art

A display apparatus may process image signals or image data received from the outside according to various image processing processes. The display apparatus may display the processed image signal as an image on a display panel.

The image data may be transmitted from a transmission unit to a reception unit using an interface according to a set standard. The transmission unit and the reception unit may each be implemented as a device or as a board. An example of image data being transmitted between boards may include image data being output from an image processing board within a device to a timing controller board. For example, various transmission/reception interface standards for transmitting image data have been proposed.

One example of a transmission/reception interface for transmitting image data may include an low-voltage differential signaling (LVDS) interface, a digital video interface (DVI) interface, a high definition multimedia interface (HDMI) interface, a DisplayPort (DP) interface, and a V-by-One interface (which may also be referred to as a Vx1 interface).

Here, the Vx1 interface may have a form which adopts a clock embedded process in which a data signal and clock information are transmitted through a single signal line. In the clock embedded process, clock information may be embedded in a data signal, the clock information may be extracted from a clock data recovery (CDR) circuit of the reception unit, and image data may be synchronized with the clock information. Because in the V-by-One interface, the transmission unit does not transmit a separate clock, a problem which may occur in the LVDS interface, such as a data signal and a clock signal being transmitted through separate signal lines (e.g., a skew adjustment problem resulting from clock transmission), is resolved.

As an example, the display apparatus according to some approaches may process and transmit image data by using a fixed clock. Here, the clock may represent a speed at which image data of the data signal, which is a digital signal, may be transmitted. The clock used to transmit image data may be synchronized with a frame rate of an image, and accordingly, timing for a certain amount of image data may be transmitted each time the screen of the display panel is refreshed. In the display apparatus according to these approaches, power consumption may be mainly reduced through backlight or screen settings, but there may be a limitation of not being able to directly reduce power consumption in signal processing or transmission.

In addition, in some approaches, a fixed clock frequency tailored to a high frame rate may be used, which may result in unnecessarily high power consumption even when the frame rate of an image input to the display apparatus is low. This may be problematic, especially when low-frame rate content is reproduced, which may lead to energy waste.

### SUMMARY

In accordance with an aspect of the disclosure, a display apparatus includes: transmission circuitry; reception circuitry; a transmission/reception interface configured to connect the reception circuitry to the transmission circuitry; at least one processor; and memory configured to store instructions. The instructions, when executed by the at least one processor, individually or collectively, cause the display apparatus to detect a frame rate of an input image. The instructions, when executed by the at least one processor, individually or collectively, cause the display apparatus to adjust a clock parameter of a clock signal based on the detected frame rate to generate an adjusted clock signal. The instructions, when executed by the at least one processor, individually or collectively, cause the display apparatus to transmit a data signal generated based on the adjusted clock signal and image data corresponding to the input image, from the transmission circuitry to the reception circuitry using the transmission/reception interface.

In accordance with an aspect of the disclosure, a method of operating a display apparatus including transmission circuitry, reception circuitry, and a transmission/reception interface configured to connect the transmission circuitry to the reception circuitry includes: detecting a frame rate of an input image; adjusting a clock parameter of a clock signal based on the detected frame rate to generate an adjusted clock signal; and transmitting a data signal generated based on the adjusted clock signal and image data corresponding to the input image, from the transmission circuitry to the reception circuitry using the transmission/reception interface.

In accordance with an aspect of the disclosure, a non-transitory computer-readable recording medium has recorded thereon instructions which, when executed by at least one processor of an electronic device, individually or collectively, cause the electronic device to: detect a frame rate of an input image; adjust a clock parameter of a clock signal based on the detected frame rate to generate an adjusted clock signal; and transmit a data signal generated based on the adjusted clock signal and image data corresponding to the input image, from transmission circuitry included in the electronic device to reception circuitry included in the electronic device using a transmission/reception interface included in the electronic device.

### BRIEF DESCRIPTION OF THE DRAWINGS

The disclosure may be readily understood by a combination of the detailed description below and the accompanying drawings, in which reference numerals refer to structural elements.

FIG. 1 is a drawing for describing an operation of generating different clock signals according to a frame rate of content input to a display apparatus, according to an embodiment of the disclosure.

FIG. 2 is a schematic block diagram of a display apparatus according to an embodiment of the disclosure.

FIG. 3 is a block diagram of a configuration for signal transmission between a first board and a second board through a transmission/reception interface of a display apparatus according to an embodiment of the disclosure.

FIG. 4 is a block diagram of a configuration for a display apparatus to adjust a clock parameter of a clock signal, according to an embodiment of the disclosure.

FIG. 5 is a drawing for describing a format of a data signal transmitted by a transmission/reception interface, according to an embodiment of the disclosure.

FIG. 6 is a flowchart for describing an operation of ae display apparatus according to an embodiment of the disclosure.

FIG. 7 is a flowchart for describing an operation of generating, by a display apparatus, a clock signal by adjusting a clock parameter, according to an embodiment of the disclosure.

FIG. 8 is a table showing an example of clock parameters adjusted according to frame rates of an input image, according to an embodiment of the disclosure.

FIG. 9 show examples of data signals with adjusted clock parameters according to an embodiment of the disclosure.

FIG. 10 is a detailed flowchart for describing an operation of generating, by a display apparatus, different clock signals according to a frame rate of content, according to an embodiment of the disclosure.

FIG. 11 is an example of an operation of transmitting, by a display apparatus, a signal through a transmission/reception interface, according to an embodiment of the disclosure.

FIG. 12 is an example of an operation of transmitting, by a display apparatus, a signal through a transmission/reception interface, according to an embodiment of the disclosure.

FIG. 13 is a drawing for describing an operation of a display apparatus when an image input to the display apparatus is changed, according to an embodiment of the disclosure.

FIG. 14 is a detailed flowchart for describing an operation of generating, by a display apparatus, different clock signals according to a frame rate of content, according to an embodiment of the disclosure.

FIG. 15 is a detailed block diagram of a display apparatus according to an embodiment of the disclosure.

### DETAILED DESCRIPTION

As used herein, expressions such as “at least one of”, when preceding a list of elements, modify the entire list of elements and do not modify the individual elements of the list. For example, the expression “at least one of a, b, or c” should be understood as including only “a”, only “b”, only “c”, both “a and b”, both “a and c”, both “b and c”, “all of a, b, and c”, or any other variations thereof.

As used herein, when a first element and a second element are described as being “connected to each other”, this may be referred to as the first element being “connected to” the second element, and may also be referred to as that the second element being “connected to” the first element.

As is traditional in the field, the embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the present scope. Further, the blocks, units and/or modules of the embodiments may be physically combined into more complex blocks, units and/or modules without departing from the present scope.

As used herein, when an action or operation is referred to as occurring “in response to” an event or occurrence, this may mean that action or operation occurs directly or indirectly in response to or based on the event or occurrence.

Hereinafter, some example embodiments of the disclosure are described in detail with reference to the accompanying drawings so that embodiments of the disclosure may be readily implemented by one of ordinary skill in the art. However, the disclosure may be embodied in many different forms and is not limited to the particular embodiments described herein.

Although functions are described in the disclosure using current general terms, this may mean various other terms depending on the intention of a technician working in the field, precedents, the emergence of new technologies, or the like. Thus, the terms used herein should not be interpreted only by their names, but should be defined based on the meaning of the terms together with the description throughout the disclosure.

In addition, the terms used herein are intended to described some example embodiments of the disclosure, and are not intended to limit the scope of the disclosure.

When the description indicates that a part “includes” or “comprises” an element, the part may further include other elements, not excluding the other elements, unless there is a particular description contrary thereto. In addition, terms, such as “-unit” or “module”, described in the specification mean a unit which processes at least one function or operation, which may be implemented by hardware or software, or by a combination of hardware and software.

When an element in the description is referred to as being “connected to” or “coupled to” another element, it should be understood that the element may be directly connected or coupled to the other element, but may also be connected or coupled with another element in between (e.g., indirectly coupled), unless otherwise specifically stated.

Below, embodiments are described in detail with reference to the accompanying drawings so that a person skilled in the art may easily implement the embodiment. However, the disclosure may be implemented in various different forms and is not limited to the particular embodiments described herein. In addition, in the drawings, some parts or portions may be omitted for convenience of depiction and description, and like reference numerals designate like elements throughout the specification.

As used herein, a “processor” may include various processing circuitry and/or a plurality of processors. For example, the term “processor” as used herein, including in the claims, may include various processing circuitry, including at least one processor. In the at least one processor, one or more processors may be configured to individually and/or collectively perform various functions described herein, in a distributed manner. As used herein, “processor,” “at least one processor,” and “one or more processors” may be configured to perform various functions. However, these terms cover, without limitation, a situation in which one processor performs some of the functions and other processor(s) perform other parts of the functions, and situations where a single processor may perform all of the functions. In addition, at least one processor may include a combination of processors configured to perform various functions of the disclosed functions in a distributed manner. At least one processor may execute program instructions to accomplish or perform various functions.

As use herein, the term “user” may refer to a person who controls a system, function, or operation, and may include an engineer, an administrator, an installer, or a repair technician.

As used herein, an “image” may include a still image, graphics, a picture, a frame, a moving image including a plurality of consecutive still images, or a video.

Below, embodiments are described in detail with reference to the accompanying drawings.

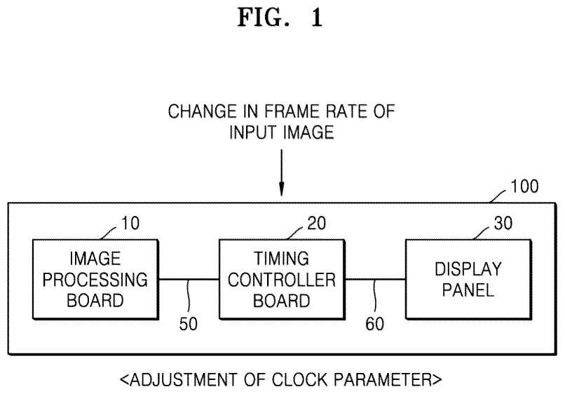

FIG. 1 is a drawing for describing an operation of generating different clock signals according to a frame rate of content input to a display apparatus, according to an embodiment of the disclosure.

Referring to FIG. 1, in an embodiment of the disclosure, a display apparatus 100 may provide an image to a user by displaying the image. For example, the display apparatus 100 may include at least one of a television (TV), a smartphone, a tablet personal computer (PC), a digital camera, a camcorder, a laptop computer, a desktop, an e-book reader, a digital broadcasting terminal, a personal digital assistant (PDA), a portable multimedia player (PMP), a navigation device, an MP3 player, a wearable device, a smart watch, a home network system, a security system, a medical device, a head-mounted display (HMD), a hemispherical display, a large display, and a projector display.

In an embodiment of the disclosure, the display apparatus 100 may process image data received from the outside (e.g., from an outside of the display apparatus 100) according to various image processing processes. The display apparatus 100 may display the processed image data as an image on a display. An image input to the display apparatus 100 may include a plurality of frames. Each image may have a certain frame rate, and the frame rate may indicate a number of frames per second or a speed at which the frames are reproduced. The display apparatus 100 may refresh the image in each of the plurality of frames and display the image on the display.

In an embodiment of the disclosure, the display apparatus 100 may include an image processing board 10 which processes image data, a timing controller board 20 which generates a driving control signal corresponding to the image data transmitted from the image processing board 10, and a display panel 30 on which the image data is displayed as an image according to the driving control signal output from the timing controller board 20. However, the board structure inside the display apparatus 100 is not limited thereto. For example, in FIG. 1, the image processing board 10 and the timing controller board 20 are illustrated as separate boards. However, the image processing board 10 and the timing controller board 20 may be implemented in a single board. In some embodiments, for example, the timing controller board 20 and the display panel 30 may be implemented in a single board.

According to embodiments, each of the image processing board 10, the timing controller board 20, and the display panel 30 may be, or may include a circuit board (e.g., a printed circuit board) on which one or more components or elements are mounted or otherwise attached. However, embodiments are not limited thereto. For example, in some embodiments, at least one of the image processing board 10, the timing controller board 20, or the display panel 30 may be, or may include, a unit or module, as described above. For example, in some embodiments, the image processing board 10, may be, or may include, an image processing unit or an image processing module, the timing controller board 20 may be, or may include, a timing controller unit or a timing controller module, and the display panel 30 may be, or may include, a display unit or a display module.

In an embodiment of the disclosure, the image processing board 10, the timing controller board 20, and the display panel 30 may be connected through various types of transmission/reception interfaces (e.g., transmission/reception interface 50 and transmission/reception interface 60) such that image transmission and reception may be performed. The transmission/reception interface may be implemented as, for example, a cable, and each of a transmission board and a reception board may include one or more signal input/output ports for cable connection. The format of a data signal exchanged between the transmission board and reception board may vary depending on the type of the transmission/reception interface. The one or more signal input/output ports may transmit or receive a data signal which complies with specifications of the connected transmission/reception interface.

For example, the display apparatus 100 may include a transmission/reception interface 50 connecting the image processing board 10 and the timing controller board 20 to each other (e.g., connecting the image processing board 10 with or to the timing controller board 20) and a transmission/reception interface 60 connecting the timing controller board 20 and the display panel 30 to each other (e.g., connecting with or to the timing controller board 20 to the display panel 30). Using the transmission/reception interface, data may be transmitted from the image processing board 10 to the timing controller board 20, and also from the timing controller board 20 to the display panel 30.

The image processing board 10 may process the image input to the display apparatus 100 according to various image processing processes and output the processed image data to the timing controller board 20. The image processing process performed in the image processing board 10 may include at least one of, for example, de-multiplexing for dividing an input transmission stream into sub-streams of a video signal, an audio signal, and additional data, decoding corresponding to an image format of an image signal, scaling for adjusting an image signal to a preset resolution, noise reduction for improving image quality, detail enhancement, frame rate conversion, or the like.

In addition to the image processing process described above, the image processing board 10 may perform various processes depending on the type and characteristics of data. The image processing board 10 may be implemented by mounting, on a printed circuit board, a system-on-chip (SoC), which is obtained by integrating the above-described functions into a single chip, or individual chip sets which may independently perform each process. The image processing board 10 may include at least one processor for performing various processes.

The timing controller board 20 may include a timing controller and may adjust an amount of data transmitted to the display panel 30 and control each driving circuitry included in the display panel 30. The timing controller board 20 may transmit image data received from the image processing board 10 to each driving circuitry. The timing controller board 20 may be referred to as a T-con board.

The display panel 30 may include a pixel array and driving circuitry for driving the pixel array. The driving circuitry may drive the display panel 30 by using the image data received from the timing controller board 20, and the display panel 30 may display the image data as an image.

In an embodiment of the disclosure, the display apparatus 100 may process and transmit a certain amount of image data by using a clock. Here, the clock may provide timing for processing and transmitting data in a digital signal. For example, the clock may be synchronized with the frame rate of an image so that timing for a certain amount of image data is transmitted each time a screen of the display panel is refreshed. Here, a frequency of a clock signal (which may be referred to as a clock frequency) may refer to a value indicating how many cycles the clock signal generates per second, and may determine a speed at which image data is transmitted through the transmission/reception interface (e.g., a data transmission speed) and a data processing speed. For example, when the clock frequency decreases, the clock speed may decrease, and the transmission speed of image data may decrease. As another example, when the clock frequency increases, the clock speed may increase, and the transmission speed of image data may increase. For example, based on the adjusted clock frequency, the data transmission rate of a data signal may be adjusted.

The frame rate of the image input to the display apparatus according to an embodiment of the disclosure may be variable. For example, the display apparatus 100 may process and/or transmit a high-frame rate image and then process and/or transmit a low-frame rate image, or may process and/or transmit a low-frame rate image and then process and/or transmit a high-frame rate image. For example, when the display apparatus 100 processes and/or transmits the low-frame rate image using the same clock frequency used while processing and/or transmitting the high-frame rate image, unwanted power consumption may occur. As an example, a clock frequency of 95 megahertz (MHz) may be used to transmit 165 Hz image data from a transmission circuitry to a reception circuitry, and the frame rate of the image may be changed to 60 hertz (Hz). When the transmission circuitry transmits 60 Hz image data to the reception circuitry by using a fixed 95 MHz clock frequency, the amount of data transmitted per second may decrease, resulting in lower efficiency and increased power consumption.

According to an embodiment of the disclosure, in order to reduce the power consumption described above, the display apparatus 100 may generate clock signals having different frequencies according to a change in the frame rate of an input image. For example, the display apparatus 100 may identify or detect the frame rate of the input image. The display apparatus 100 may generate a clock signal with an adjusted clock frequency (e.g., an adjusted clock signal having an adjusted clock frequency) based on the identified or detected frame rate. The display apparatus 100 may transmit a data signal corresponding to the adjusted clock frequency from the transmission circuitry to the reception circuitry using the transmission/reception interface. Here, when the transmission circuitry is included in the image processing board 10, the reception circuitry may be included in the timing controller board 20, and when the transmission circuitry is included in the timing controller board 20, the reception circuitry may be included in the display panel 30.

For example, based on determining that the changed frame rate is a low frame rate, the display apparatus 100 may generate a clock signal having a low frequency. As another example, based on determining that the changed frame rate is a high frame rate, the display apparatus 100 may generate a clock signal having a high frequency. As used herein, the terms “low” and “high” may be terms that are relative to each other. For example, a “low” frequency may refer to a first frequency and a “high” frequency may refer to a second frequency that is higher than the first frequency. Similarly, a “low” frame rate may refer to a first frame rate, and a “high” frame rate may refer to a second frame rate that is higher than the first frame rate. The display apparatus 100 may transmit and receive image data at a speed corresponding to the clock signal having the changed frequency (e.g., the adjusted clock signal). For example, the display apparatus 100 may adjust a transmission speed of a data signal according to the frame rate of the input image.

For example, in FIG. 1, the image processing board 10 may transmit a data signal to the timing controller board 20 at the speed of the clock signal using the transmission/reception interface 50. Based on the frame rate of the input image being changed from a high frame rate to a low frame rate, the image processing board 10 may generate a clock signal having a low frequency and transmit the data signal to the timing controller board 20 at a low speed. Conversely, based on the frame rate of the input image being changed from a low frame rate to a high frame rate, the image processing board 10 may generate a clock signal having a high frequency and transmit the data signal to the timing controller board 20 at a high speed.

Here, when the frequency of the clock signal decreases, the clock speed may decrease, and when the clock speed decreases, the power consumption of the display apparatus 100 may decrease. This is because, when the clock speed decreases, the switching power, leakage power, and dynamic power of the display apparatus 100 may decrease. For example, switching power may refer to the power consumed when a transistor within a device turns on and off, and when the clock speed increases, switching power may increase because a frequency of switching transistors increases. For example, in a case of leakage power, when a clock speed increases, more transistors may be simultaneously activated, thereby increasing leakage power. For example, in the case of dynamic power, when the clock speed increases, the amount of processable data may increase, which may increase a load on the circuitry being processed, and accordingly, dynamic power may increase.

In addition, in order to reduce the power consumption described above, in the display apparatus 100 according to an embodiment of the disclosure, the clock parameter of the clock signal may be adjusted according to a change in the frame rate of the input image. Here, the clock parameter may define, describe, specify, or otherwise indicate or correspond to the characteristics and operation of the clock signal, and may include at least one of a clock frequency of the clock signal, a voltage strength of the clock signal, or a ratio of the spread spectrum clock (SSC) of the clock signal. Here, the voltage strength of the clock signal may be re-expressed as a voltage level, and may indicate voltage values in the “high” and “low” states of the clock signal (e.g., logic high and logic low states of the clock signal). Here, SSC may refer to a technology for reducing electromagnetic interference (EMI) by adjusting a variable range of a clock frequency, and the variable range of the clock frequency may be adjusted using an SSC ratio of the clock signal. For example, when a 0.1% SSC is applied to a 100 mHz clock, the clock speed may be spread from about 99.5 MHz to about 100.5 MHz. However, embodiments are not limited thereto, and the clock parameter may further include a period, duty cycle, phase, waveform shape, transition time, or the like of the clock signal.

For example, the display apparatus 100 may generate clock signals having different voltage strengths depending on a change in the frame rate of the input image. For example, based on determining that the changed frame rate is a low frame rate, the display apparatus 100 may generate a clock signal having a low voltage strength. In addition, for example, based on determining that the changed frame rate is a high frame rate, the display apparatus 100 may generate a clock signal having a high voltage strength. The display apparatus 100 may transmit and receive image data using a transmission/reception interface in response to a clock signal having a changed voltage strength.

For example, the display apparatus 100 may set an SSC application ratio of the clock signal differently depending on the change in the frame rate of the input image. For example, based on determining that the changed frame rate is a low frame rate, the display apparatus 100 may generate a clock signal to which a high rate of SSC is applied. In addition, for example, based on determining that the changed frame rate is a high frame rate, the display apparatus 100 may apply a low rate SSC or generate a clock signal to which SSC is not applied. The display apparatus 100 may transmit and receive the image data using the transmission/reception interface in response to a clock signal having a changed SSC ratio.

Here, when the clock speed decreases, an eye margin of the clock signal may widen so that signal transmission may become stable, allowing stable signal transmission even with a relatively low-intensity voltage. Accordingly, when the clock speed decreases, the voltage strength of the clock signal may be lowered. When the voltage strength decreases, the power consumption may decrease. In addition, when the eye margin of the clock signal widens, the impact on signal quality may be reduced even when more SSC is applied. When the SSC ratio increases, EMI may be reduced as electromagnetic energy is dispersed, so that system efficiency is improved, thereby reducing power consumption. Here, improved system efficiency may refer to improved protection circuitry, reduced filter load, improved signal integrity, error minimization, minimization of signal interference, or the like.

According to an embodiment of the disclosure, in order for high-resolution image data to be transmitted between the transmission circuitry and the reception circuitry, a transmission/reception interface convention or specification that is agreed upon or specified in advance may be applied. For example, the display apparatus 100 may convert the image data into a data signal which may be transmitted according to, or in compliance with, a specification of the transmission/reception interface. For example, the display apparatus 100 may convert a clock signal generated through the above-described process into a data signal which may be transmitted according to the specification of the transmission/reception interface. The display apparatus 100 may transmit the clock signal with the adjusted clock parameter and the data signal corresponding to the image data from the transmission circuitry to the reception circuitry through the transmission/reception interface. For example, the transmission/reception interface may include at least one of a low-voltage differential signaling (LVDS) interface or a V-by-One interface (which may be referred to as a Vx1 interface).

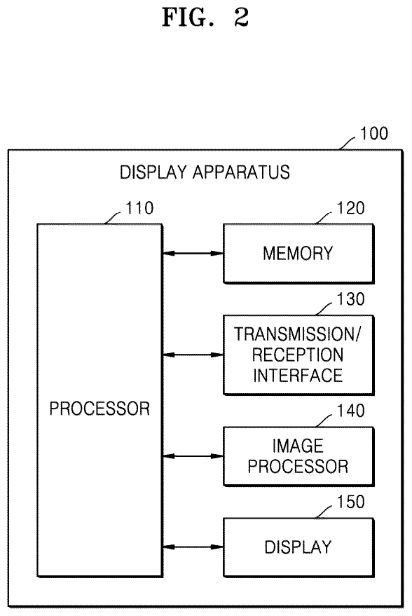

FIG. 2 is a schematic block diagram of the display apparatus according to an embodiment of the disclosure.

Referring to FIG. 2, the display apparatus 100 according to an embodiment of the disclosure may include a processor 110, memory 120, a transmission/reception interface 130, an image processor 140, and a display 150. However, embodiments are not limited thereto, and in some embodiments, the display apparatus 100 may be implemented using more elements than those shown in FIG. 2, or may be implemented using fewer elements.

In the example shown in FIG. 2, embodiment of the disclosure, the processor 110 is illustrated as a separate element from the image processor 140. However, embodiments are not limited thereto, and in some embodiments the processor 110 may be implemented as a single SoC by being integrated with a chipset having various functions, including the image processor 140. For example, the image processor 140 and the processor 110 may be implemented on the image processing board 10 (as shown, for example, in FIG. 1). In addition, in some embodiments, the transmission/reception interface 130 and memory 120 may be additionally installed on the image processing board 10 of FIG. 1, or may be separated from the image processing board 10 of FIG. 1.

The processor 110 may control an overall operation of the display apparatus 100. For example, the processor 110 may execute one or more instructions stored in the memory 120 to perform functions of the display apparatus 100 described herein. For example, the memory 120 may store one or more instructions executable by the processor 110. In addition, the processor 110 may store the one or more instructions in an internally provided memory, and execute the one or more instructions stored in the internally provided memory to control the above-described operations to be performed. The processor 110 may execute the one or more instructions or a program stored in the internally provided memory to perform a certain operation.

The processor 110 may include, but is not limited to, at least one of a central processing unit, a microprocessor, a graphics processing unit, an application processor (AP), application specific integrated circuits (ASICs), digital signal processors (DSPDs), programmable logic devices (PLDs), field programmable gate arrays (FPGAs), a neural processing unit, or an artificial intelligence-dedicated processor designed in a hardware structure specialized for training and processing artificial intelligence (AI) models.

The memory 120 may store instructions, algorithms, data structures, program codes, and application programs for the processor 110 to perform processing and control, and may store data input to or output from the display apparatus 100. The memory 120 may include at least one of a flash memory type, a hard disk type, a multimedia card micro type, a card type memory (such as Secure Digital (SD) or extreme Digital (XD) memory), random access memory (RAM), static random access memory (SRAM), read-only memory (ROM), electrically erasable programmable read-only memory (EEPROM), a programmable read-only memory (PROM), a mask ROM, a flash ROM, a hard disk drive (HDD), or a solid state drive (SSD). A program (e.g., one or more instructions) or application stored in the memory 120 may be executed by the processor 110.

In an embodiment of the disclosure, the transmission/reception interface 130 may transmit data from a transmission unit to a reception unit. For example, the transmission/reception interface 130 may transmit data from an image input source (e.g., an external device) to the display apparatus 100. In some embodiments, for example, the transmission/reception interface 130 may transmit data from the image processing board 10 to the timing controller board 20. In some embodiments, for example, the transmission/reception interface 130 may transmit data from the timing controller board 20 to display driving circuitry.

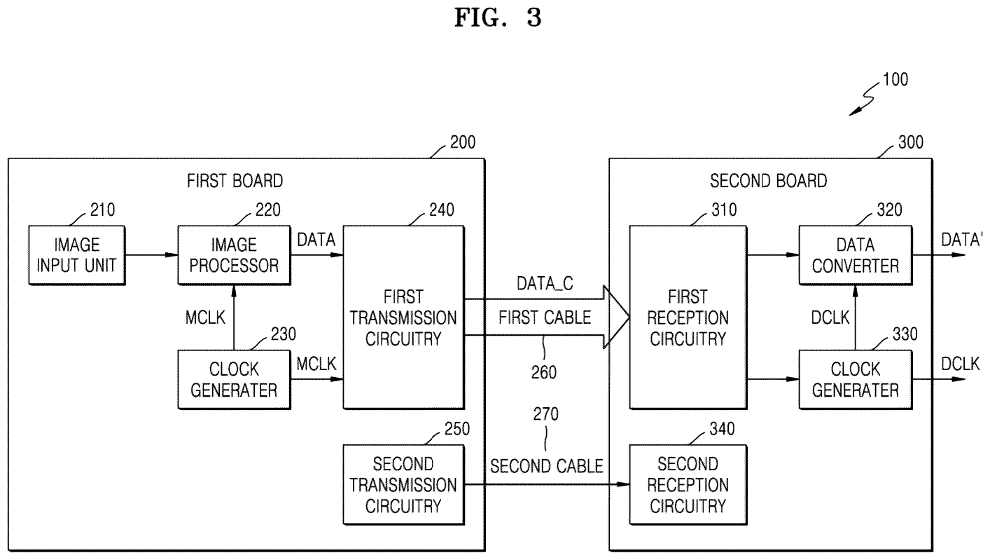

In an embodiment of the disclosure, the transmission/reception interface 130 may receive an image signal from various image input sources. For example, the transmission/reception interface 130 may receive video (e.g., moving images), audio (e.g., voice, music, or the like), and additional information (e.g., an electronic program guide (EPG) or the like) from an external device under the control by the processor 110. The transmission/reception interface 130 may output the video received from the external device to the image processor 140. The transmission/reception interface 130 may include at least one of a high-definition multimedia interface (HDMI), mobile high-definition link (MHL), universal serial bus (USB), display port (DP), thunderbolt, video graphics array (VGA) port, red-green-blue (RGB) port, D-subminiature (D-SUB), digital visual interface (DVI), component jack, or a PC port. However, embodiments are not limited thereto, and the transmission/reception interface 130 may include various types of interfaces capable of receiving input images from peripheral electronic apparatuses. In some embodiments, the transmission/reception interface 130 for receiving image signals received from various image input sources may be referred to as an image input unit 210 (as shown, for example, in FIG. 3).

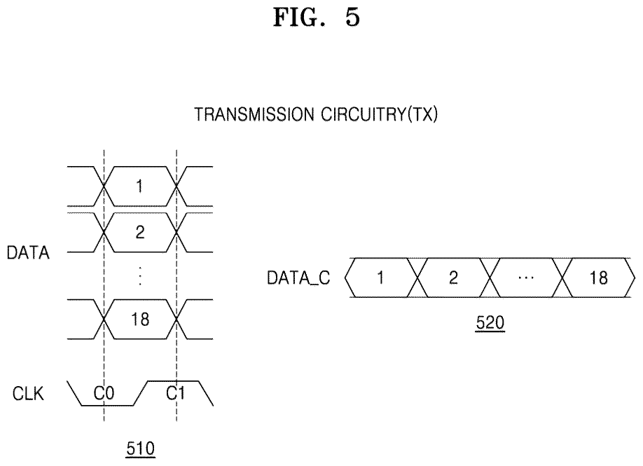

In an embodiment of the disclosure, the transmission/reception interface 130 may transmit image data processed in the image processor 140 from the transmission circuitry to the reception circuitry under the control by the processor 110. In an embodiment of the disclosure, data signals exchanged between the transmission circuitry and the reception circuitry may vary depending on the type of the transmission/reception interface 130. The processor 110 may convert the image data into a data signal which may be transmitted according to a specification of the transmission/reception interface. For example, the transmission/reception interface 130 may include a high-speed interface, such as an LVDS interface or a Vx1 interface, capable of transmitting image data. The format of data signals which may be transmitted according to each interface standard is described with reference to FIG. 5. In some embodiments, the transmission/reception interface 130 for transmitting image data between a transmission board and a reception board may be referred to as a first cable 260 (an example of which is discussed below with reference to FIG. 3).

In an embodiment of the disclosure, the transmission/reception interface 130 may include a low-speed interface, such as inter-integrated circuit (I2C) or USB, under the control by the processor 110. The low-speed interface may be used to convey at least one of frame rate information of an input image, display configuration information (e.g., resolution, brightness, color, or the like), clock frequency information, a control command such as a reset command, or the like. In some embodiments, the transmission/reception interface 130 for transmitting a control command between the transmission board and the reception board may be referred to as a second cable 270 (an example of which is discussed below with reference to FIG. 3).

The image processor 140 may process image data received by the display apparatus 100, under the control by the processor 110. The image processor 140 may perform various image processing, such as at least one of decoding, scaling, noise reduction, frame rate conversion, or resolution conversion on image data.

The display 150 may display an image according to the received image data under the control by the processor 110. The display 150 according to an embodiment of the disclosure may include at least one of a timing controller, a source driver, a gate driver, or a display panel.

The display 150 may include at least one of a liquid crystal display (LCD), a thin-film transistor-liquid crystal display, a light-emitting diode (LED), an organic light-emitting diode (OLED), a micro LED, a flexible display, a three-dimensional (3D) display, or an electrophoretic display.

FIG. 3 is a block diagram of a configuration for signal transmission between a first board and a second board using a transmission/reception interface of the display apparatus according to an embodiment of the disclosure.

Referring to FIG. 3, the display apparatus 100 according to an embodiment of the disclosure may include a first board 200, a second board 300, a first cable 260, and a second cable 270. FIG. 3 illustrates an example in which the first board 200 is an image processing board 10 (as shown, for example, in FIG. 1), and the second board 300 is an timing controller board 20 (as shown, for example, in FIG. 1). However, embodiments are not limited thereto, and when the first board 200 is the timing controller board 20, the second board 300 may be a display panel 30 (as shown, for example, in FIG. 1).

The first cable 260 may include a Vx1 interface. According to the Vx1 interface specification, a clock signal may not be transmitted alone during an image transmission process, and instead may be transmitted by including the clock signal in the image data. Therefore, when data is transmitted by using the Vx1 interface, clock embedded may be performed during the transmission process, and clock data recovery (CDR) may be performed during the reception process.

The second cable 270 may include an I2C interface. The I2C interface may be an interface for transmitting a control command.

First, the first board 200 may include an image input unit 210, an image processor 220, a clock generator 230, a first transmission circuitry 240, and a second transmission circuitry 250.

The image input unit 210 may receive an image signal from various image input sources. For example, the image input unit 210 may include a tuner for receiving a live stream coming in using a broadcast, USB for reproducing video, HDMI for receiving external input, component, or the like.

The clock generator 230 may generate a clock signal MCLK used for data processing and data transmission of the first board 200. Here, the clock signal MCLK generated in the first board 200 may be referred to as a main clock signal MCLK to distinguish the main clock signal MCLK from a data clock signal DCLK generated in the second board 300 described below. The clock generator 230 may transmit the clock signal MCLK to the image processor 220 and the first transmission circuitry 240.

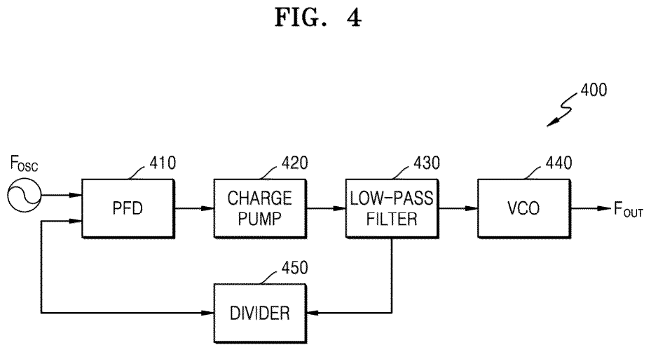

For example, clock generator 230 may include phase-locked loop (PLL) circuitry for adjusting the clock frequency of the clock signal. In addition, for example, the clock generator 230 may include a voltage regulation module for regulating a voltage strength of the clock signal or an SSC modulator for applying SSC to the clock signal. An example of this is described in detail with reference to FIG. 4.

The image processor 220 may process an image signal received from the image input unit 210. The image processor 220 may generate image data DATA by converting the processed image signal in synchronization with the clock signal MCLK received from the clock generator 230. The image processor 220 may transmit the image data DATA to the first transmission circuitry 240. The image processor 220 may correspond to the image processor 140 (as shown, for example, in FIG. 2).

The first transmission circuitry 240 may convert image data into a format according to or in compliance with an interface specification established for transmission of image data. For example, the first transmission circuitry 240 may convert the image data DATA into a format of the first cable 260. For example, the first transmission circuitry 240 may embed information about the clock signal MCLK into the image data DATA so that a clock embedded data signal DATA_C may be generated. The data signal DATA_C may include information about the clock signal MCLK and the image data DATA. The image data DATA included in the data signal DATA_C may be transmitted according to a speed of the clock signal MCLK. A data transmission cycle of the first transmission circuitry 240 may correspond to a frequency of the clock signal MCLK.

The data signal DATA_C transmitted from the first transmission circuitry 240 may be transmitted to a first reception circuitry 310 of the second board 300 using the first cable 260.

The second board 300 may include the first reception circuitry 310, a data converter 320, a clock generator 330, and a second reception circuitry 340.

The first reception circuitry 310 may receive the data signal DATA_C from the first transmission circuitry 240 using the first cable 260. A data reception cycle of the first reception circuitry 310 may correspond to the frequency of the clock signal MCLK. The first reception circuitry 310 may restore image data and a clock signal from the clock embedded data signal DATA_C. The first reception circuitry 310 may include CDR circuitry for restoring the embedded data signal. The first reception circuitry 310 may transmit the restored image data to the data converter 320 and transmit the restored clock signal to the clock generator 330.

The clock generator 330 may receive the restored clock signal from the first reception circuitry 310. The clock generator 330 may convert the restored clock signal to match settings of the display panel and generate the data clock signal DCLK. The generated data clock signal DCLK may be output to data converter 320.

According to an embodiment of the disclosure, the frequency of the main clock signal MCLK may be the same as or different from the frequency of the data clock signal DCLK. The clock generator 330 may generate the data clock signal DCLK having a certain frequency, regardless of the frequency of the main clock signal MCLK. For example, the clock generator 330 may generate the data clock signal DCLK from the restored clock signal based on the setting information of the display panel (e.g., the resolution of a display, the refresh rate of the display, or the like). For example, the clock frequency of the data clock signal DCLK may be fixed to a frequency at which the display panel may normally operate, but embodiments are not limited thereto. For example, when the first board 200 and the second board 300 are implemented as one board, the frequency of the data clock signal DCLK may change depending on the frame rate of the input image.

The data converter 320 may receive the image data restored by the first reception circuitry 310. The data converter 320 may convert the received image data by synchronizing the image data with the data clock signal DCLK, and then output the converted image data DATA′ to the display driving circuitry. The display driving circuitry may drive the display panel based on the image data DATA′ and the data clock signal DCLK.

A control command may be transmitted from the second transmission circuitry 250 to the second reception circuitry 340 using the second cable 270. The second transmission circuitry 250 may perform a control command, such as at least one of frame rate information of the input image, display setting information (e.g., at least one of resolution, brightness, color, or the like), clock frequency information, or reset command, using the second cable 270. The second reception circuitry 340 may receive the above-described control command using the second cable 270. For example, the second reception circuitry 340 may receive a reset command from the second transmission circuitry 250 using the second cable 270 and reset the first reception circuitry 310. For example, the second reception circuitry 340 may receive clock frequency information from the second transmission circuitry 250 using the second cable 270 and set or update the data reception cycle of the first reception circuitry 310.

Although the first cable 260 is described above as a Vx1 interface, embodiments are not limited thereto. For example, in some embodiments, the first cable 260 may be another type of image transmission interface, such as an LVDS interface. For example, functions and operations of the first transmission circuitry 240 and the first reception circuitry 310 may be changed to perform signal processing which conforms to the specifications of each interface.

Although the first transmission circuitry 240 and the second transmission circuitry 250 are referred to above as “transmission unit”, embodiments are not limited thereto. For example, in some embodiments, the first reception circuitry 310 and the second reception circuitry 340 may be referred to as “reception unit”.

FIG. 4 is a block diagram of a configuration for the display apparatus to adjust a clock parameter of a clock signal, according to an embodiment of the disclosure.

Referring to FIG. 4, the display apparatus 100 may include PLL circuitry 400. The PLL circuitry 400 may be circuitry used to amplify a frequency received from an oscillator or to generate a fixed frequency. The PLL circuitry 400 may adjust the clock frequency of a clock signal using a phase difference between an input signal with a frequency of several tens of MHz and a feedback signal at the output.

The PLL circuitry 400 may include a voltage-controlled oscillator (VCO) 440 configured to modulate a frequency according to an input voltage, a divider 450 configured to divide an output frequency of the VCO 440 by a specific ratio, a phase frequency detector (PFD) 410 configured to compare phases of an input frequency f_{osc} and the VCO output frequency and control the VCO 440 so that the two frequencies are synchronized with each other. The PLL circuitry 400 may further include a charge pump 420 and a low-pass filter (LPF) 430.

According to an embodiment of the disclosure, the processor 110 may control the PLL circuitry 400 to adjust the clock frequency of a clock signal. For example, in the PLL circuitry 400, an output clock frequency fₒᵤₜ may be determined according to Equation 1 below.

$${f}_{out} = \frac{N}{P * K 2} {f}_{ocs} \qquad ( Equation 1 )$$

Here, f_{osc} may denote the input clock frequency, which may be a signal coming from the oscillator, and fₒᵤₜ may denote the output clock frequency. In addition, P may denote the setting value of the divider 450 for dividing the output frequency of the VCO 440 compared to a reference frequency, K2 may denote the setting value of another divider for dividing the VCO 440 by the output frequency to obtain a desired final frequency, and N may denote the setting value of a multiplier for re-amplifying the frequency of a feedback signal divided by the divider 450. The output clock frequency fₒᵤₜ may be varied depending on the set values N, P, and K2.

For example, the processor 110 may transmit a control command to the PLL circuitry, which may include the set values N, P, and K2 for determining the output clock frequency fₒᵤₜ, so that the clock frequency may be adjusted. The processor 110 may obtain the varied output frequency fₒᵤₜ based on the control command.

In some embodiments, according to an embodiment of the disclosure, the display apparatus 100 may further include a switching module for performing switching between clock frequencies. The processor 110 may perform switching between clock frequencies to adjust the clock frequency. For example, the processor 110 may use clock sources which operate at fixed frequencies, such as 95 MHz, 92 MHz, or 75 MHz. The processor 110 may execute the switching module to switch from a first clock source operating at a first frequency to a second clock source operating at a second frequency according to the frame rate of an input image.

According to an embodiment of the disclosure, the display apparatus 100 may further include a voltage regulation module for controlling the voltage strength of a clock signal. The voltage regulation module may include dynamic voltage and frequency scaling (DVFS), low dropout regulator (LDO), or the like. The processor 110 may control the voltage strength of the clock signal through the voltage regulation module.

According to an embodiment of the disclosure, the display apparatus 100 may further include an SSC modulator for adjusting a ratio of SSC of the clock signal. The SSC modulator may receive a clock signal having an output frequency of the PLL circuitry 400. The SSC modulator may vary the output frequency and generate a modulated clock frequency. The SSC modulator may vary the frequency and expand a variable range of frequencies. The processor 110 may control the SSC modulator to generate a modulated clock frequency.

FIG. 5 is a drawing for describing a format of a data signal transmitted by the transmission/reception interface, according to an embodiment of the disclosure.

Referring to FIG. 5, a data signal 510 may include a clock signal CLK and the image data. In the data signal 510, the clock signal CLK and the image data may be separated into separate signals. The data signal 510 may be generated in the image processor 220 (as shown, for example, in FIG. 3) before being processed using clock embedded processing.

In some embodiments, the data signal 510 may be transmitted in accordance with the specifications of the LVDS interface. The LVDS interface may include separate data lines and clock lines, so that the clock signal CLK and the image data of the data signal 510 may be transmitted separately.

A data signal 520 may have a clock embedded form in which information about a clock signal is reflected in (e.g., included in or represented in) image data. The data signal 520 may be transmitted in accordance with the specifications of the Vx1 interface. In the Vx1 interface, the data signal 520 may be transmitted using a single line (e.g., a single cable or wire).

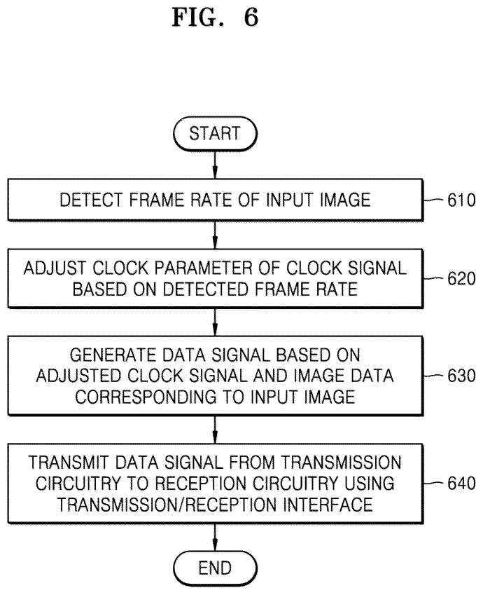

FIG. 6 is a flowchart for describing an operation of the display apparatus according to an embodiment of the disclosure.

Referring to FIG. 6, operation 610, operation 620, and operation 630 may be performed by a processor of the display apparatus 100 (e.g., the processor 110 discussed above with reference to FIG. 2). The process of operating the display apparatus 100 is not limited to the example shown in FIG. 6, and any one of the operations shown in FIG. 6 may be omitted, or operations not shown in FIG. 6 may be further included. FIG. 6 is described in connection with FIG. 3.

At operation 610, the display apparatus 100 may identify or detect a frame rate of an input image.

The display apparatus 100 according to an embodiment of the disclosure may receive an input image from various input sources connected using a cable or wirelessly. For example, the display apparatus 100 may be connected to an external device through the image input unit 210 (as shown, for example, in FIG. 3), such as HDMI, and may receive various images. In some embodiments, for example, the display apparatus 100 may be connected to an external device using a communication module, such as Wireless Fidelity (Wi-Fi) or wireless local area network (WLAN), and may receive an image.

In the display apparatus 100 according to an embodiment of the disclosure, a frame rate of an input image may be identified through metadata of the input image. For example, a signal transmitted using the image input unit 210, such as HDMI, may include metadata, and the metadata may include frame rate information of the input image.

In the display apparatus 100 according to an embodiment of the disclosure, a transmission stream transmitted from various input sources may be received, and a frame number or a timestamp of a frame header included in the transmission stream may be analyzed so that a frame rate may be identified.

A process of identifying the frame rate of an input image is not limited to the example described above.

A frame rate is referred to as frames per second or refresh rate, and may have various frame rates, such as 165 Hz, 120 Hz, and 60 Hz, depending on the input image.

In the disclosure, the meaning of high frame rate and low frame rate may be relative and not limited to specific values. For example, when the frame rate of the input image decreases (e.g., from 165 Hz to 120 Hz), this may be described as the input image changing from a high frame rate to a low frame rate. As another example, when the frame rate of the input image increases (e.g., from 60 Hz to 165 Hz), this may be described as the input image changing from a low frame rate to a high frame rate.

In some embodiments, for example, the display apparatus 100 may identify the input image as being high frame rate or low frame rate when the frame rate of the input image corresponds to a value defined as high frame rate or low frame rate.

At operation 620, the display apparatus 100 may adjust a clock parameter of a clock signal based on the identified or detected frame rate. The display apparatus 100 may generate a clock signal having the adjusted clock parameter (e.g., an adjusted clock signal).

The display apparatus 100 according to an embodiment of the disclosure may generate a clock signal using the clock generator 330 (as shown, for example, in FIG. 3). The clock signal may provide timing for processing and transmitting image data. The clock parameter may define, describe, specify, or otherwise indicate or correspond to the characteristics and operation of the clock signal, and may include at least one of a clock frequency of the clock signal, a voltage strength of the clock signal, or an SSC ratio of the clock signal. The characteristics and operation of the clock signal may depend on at least one of the clock frequency, the voltage strength of the clock signal, or the SSC ratio of the clock signal. However, embodiments are not limited thereto, and the clock parameter may further include at least one of a period, duty cycle, phase, waveform shape, transition time, or the like of the clock signal.

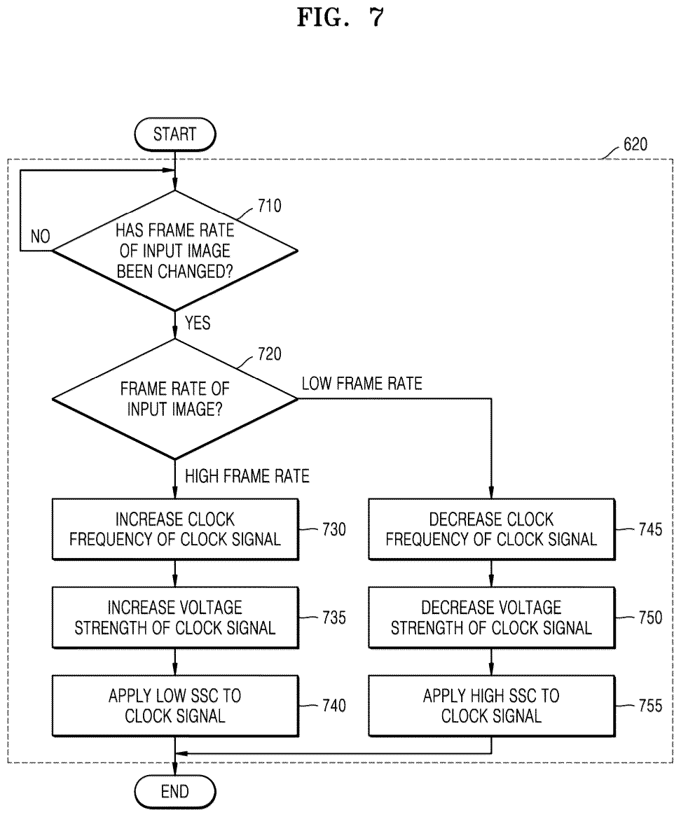

The display apparatus 100 according to an embodiment of the disclosure may generate clock signals having different frequencies according to a change in the frame rate of an input image. For example, the processor 110 (as shown, for example, in FIG. 2) may transmit a control command to the clock generator 330 (as shown, for example, in FIG. 3) and adjust at least one of a clock frequency, voltage strength, or SSC ratio. An example of this is described below in detail with reference to FIG. 7.

FIG. 7 is a flowchart for describing an operation of generating, by the display apparatus, a clock signal by adjusting the clock parameter, according to an embodiment of the disclosure.

According to embodiments, one or more of the operations shown in FIG. 7, may be performed by a processor of the display apparatus 100 (e.g., the processor 110 of FIG. 2). A process by which the display apparatus 100 operates a clock parameter is not limited to that shown in FIG. 7, and any one of the operations shown in FIG. 7 may be omitted, or operations not shown in FIG. 7 may be further included.

At operation 710, the display apparatus 100 may identify (e.g., detect or determine) whether a frame rate of an input image is changed. For example, whenever the input image changes, the display apparatus 100 may identify whether the frame rate of the input image has changed. The display apparatus 100 may proceed to operation 720 based on determining that the frame rate of the input image has changed. Based on determining that the frame rate of the input image has not changed, the display apparatus 100 may return to operation 710 again.

At operation 720, the display apparatus 100 may identify, detect, or determine whether the frame rate of the input image has increased or decreased. For example, based on determining that the frame rate of the input image has increased, the display apparatus 100 may perform at least one of operation 730, operation 735, or operation 740. As another example, based on determining that the frame rate of the input image has decreased, the display apparatus 100 may perform at least one of operation 745, operation 750, or operation 755.

At operation 730, based on determining that the frame rate of the input image has increased, the display apparatus 100 may increase a clock frequency of a clock signal. At operation 735, based on determining that the frame rate of the input image has increased, the display apparatus 100 may increase a voltage strength of the clock signal. At operation 740, based on determining the frame rate of the input image has increased, the display apparatus 100 may apply a lower rate SSC to the clock signal. For example, when the input image changes to a high frame rate, the display apparatus 100 may generate the adjusted clock signal as at least one of a clock signal having a high clock frequency, a clock signal having a high voltage strength, or a clock signal to which a low rate SSC applied.

At operation 745, based on determining that the frame rate of the input image has decreased, the display apparatus 100 may reduce a clock frequency of a clock signal. At operation 750, based on determining that the frame rate of the input image has decreased, the display apparatus 100 may increase the voltage strength of the clock signal. At operation 755, based on determining that the frame rate of the input image has decreased, the display apparatus 100 may apply a higher rate SSC to the clock signal. For example, when the input image changes to a low frame rate, the display apparatus 100 may generate the adjusted clock signal as at least one of a clock signal having a low clock frequency, a clock signal having a low voltage strength, or a clock signal with a high rate SSC applied.

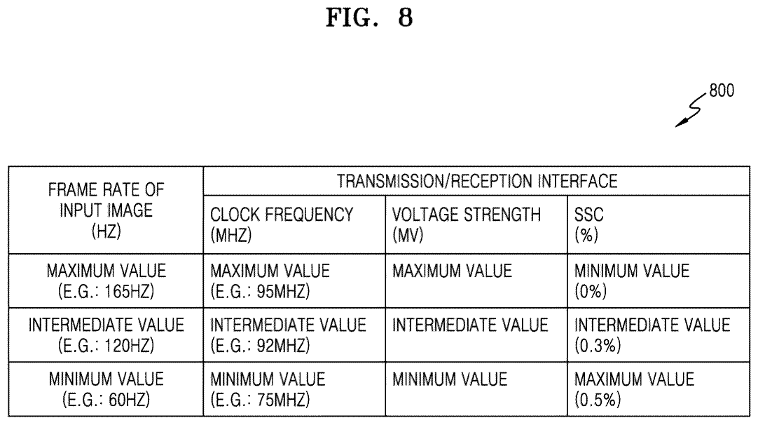

For example, based on determining that the frame rate of the input image corresponds to a value defined as the first frame rate, the display apparatus 100 may adjust the clock parameter so that the clock signal has a first clock parameter (e.g., a first clock frequency, a first voltage strength, a first ratio of SSC) set to match the first frame rate. The first clock frequency, the first voltage strength, and the first ratio of SSC may each have a predetermined value depending on whether the first frame rate is a high frame rate or a low frame rate. An example of this is described in detail with reference to a table 800 in FIG. 8.

Referring again to FIG. 6, at operation 630, the display apparatus 100 may generate a data signal based on a clock signal corresponding to the adjusted clock parameter (e.g., an adjusted clock signal) and image data corresponding to the input image.

The display apparatus 100 according to an embodiment of the disclosure may generate a clock signal having an adjusted clock parameter (e.g., an adjusted clock signal). The clock signal may have at least one of a clock frequency, voltage strength, or SSC ratio that is adjusted according to the frame rate of the input image.

The display apparatus 100 according to an embodiment of the disclosure may generate image data corresponding to the input image. The image data may be generated using the image processor 220 (as shown, for example, in FIG. 3). The image data may be synchronized to the clock signal corresponding to the adjusted clock parameter.

In order to transmit the image data using the transmission/reception interface, the display apparatus 100 according to an embodiment of the disclosure may convert the image data into a format according to a determined interface standard. For example, the display apparatus 100 may convert the clock signal having the adjusted clock parameter and the image data through the first transmission circuitry 240 (as shown, for example, in FIG. 3) into the format of a Vx1 interface. For example, display apparatus 100 may generate a clock embedded data signal by embedding information about the clock signal into the image data. The data signal may include the information about the clock signal and the image data. The data signal may have a form in which the clock signal is reflected (e.g., included or represented) in the image data.

In the disclosure, the data signal may be transmitted according to a speed of a clock signal, and the data signal may be referred to as a “data signal corresponding to a clock signal”, a “data signal corresponding to a clock parameter”, a “data signal corresponding to a clock frequency”, “image data corresponding to the speed of the clock signal”, or the like.

At operation 640, the display apparatus 100 may transmit the data signal from the transmission circuitry to the reception using the transmission/reception interface.

The display apparatus 100 according to an embodiment of the disclosure may transmit the data signal from the first transmission circuitry 240 to the first reception circuitry 310 using the first cable 260.

The clock frequency of the clock signal may determine a transmission speed of the transmission/reception interface. The display apparatus 100 may adjust the transmission speed of the data signal by adjusting the clock frequency of the clock signal according to the frame rate of the input image. Based on determining that the input image has a low frame rate, the display apparatus 100 may lower the data transmission speed of the data signal by lowering the clock frequency of the clock signal. Accordingly, power consumption resulting from transmitting the image data through the transmission/reception interface may be reduced.

For example, based on determining that the input image has a high frame rate, the display apparatus 100 may increase the data transmission speed of the data signal by increasing the clock frequency of the clock signal. Accordingly, when the image data is transmitted using the transmission/reception interface, a large amount of data may be transmitted at a high speed so that transmission efficiency may be increased.

According to an embodiment, the first reception circuitry 310 (as shown, for example, in FIG. 3) may receive a data signal and may restore the clock signal and the image data using a clock data restoration process (e.g., a CDR process). The display apparatus 100 may perform an operation for driving a display panel, as described with reference to the second board 300 of FIG. 3.

FIG. 8 is a table showing an example of clock parameters adjusted according to frame rates of an input image, according to an embodiment of the disclosure.

Referring to the table 800 of FIG. 8, for example, based on determining that the frame rate of an input image is a maximum value (e.g., 165 Hz), the display apparatus 100 may generate the adjusted clock signal by at least one of adjusting the clock frequency to a maximum value (e.g., 95 MHz), adjusting the voltage strength of the clock to a maximum value, or adjusting the SSC ratio to a minimum value (e.g., 0%). As another example, based on determining that the frame rate of the input image is an intermediate value (e.g., 120 Hz), the display apparatus may generate the adjusted clock signal by at least one of adjusting the clock frequency to an intermediate value (e.g., 92 MHz), adjusting the voltage strength of the clock to an intermediate value, or adjusting the SSC ratio to an intermediate value (e.g., 0.3%). As yet another example, based on determining that the frame rate of the input image is a minimum value (e.g., 60 Hz), the display apparatus may generate the adjusted clock signal by at least one of adjusting the clock frequency to a minimum value (e.g., 75 MHz), the voltage strength of the clock to a minimum value, or adjusting the SSC ratio to a maximum value (e.g., 0.5%).

As used herein, a maximum value, an intermediate value, and a minimum value are terms which may be used to indicate relative strength, and are not limited to specific numerical values.

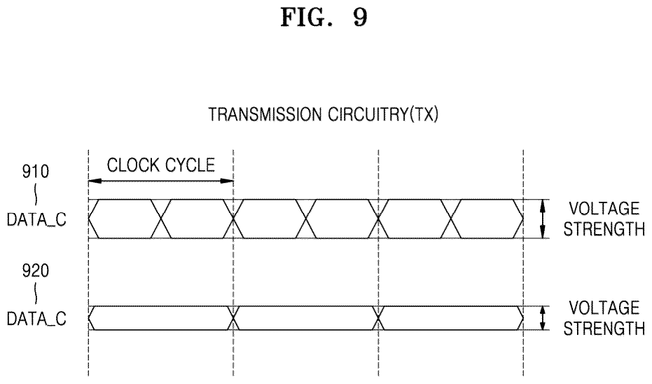

FIG. 9 show examples of data signals having adjusted clock parameters according to an embodiment of the disclosure.

Referring to FIG. 9, a data signal 910 and a data signal 920 may each be a signal in which information about a clock signal is embedded in image data.

In the data signal 910, the clock signal may have a clock frequency that is higher than a clock frequency of the data signal 920, and a voltage strength that is higher than a voltage strength of the data signal 920. For example, an amount of data transmitted during one clock cycle may be large. For example, a voltage value of the clock signal at a first level and a voltage value of the clock signal at a second level may be large. Here, the first level may be a high state (e.g., a logic high level) of the clock signal and the second level may be a low state (e.g., a logic low level) of the clock signal. The data signal 910 may be a signal used to process and transmit an image of a high frame ratio. For example, in order to transmit the high-frame rate image, the more data is transmitted during one clock cycle, the higher the transmission efficiency and the faster the transmission may be.

In the data signal 920, the clock signal may have a clock frequency that is lower a clock frequency that of the data signal 910 and a voltage strength that is lower than a voltage strength of the data signal 910. For example, an amount of data transmitted during one clock cycle may be small. For example, a voltage value of the clock signal at a first level and a voltage value of the clock signal at a second level may be small. The data signal 920 may be a signal used to process and transmit an image of a low frame ratio. For example, when a low-frame ratio image is transmitted, the amount of data is small, and thus, power is consumed less when the image is transmitted at a high speed than when the image is transmitted at a low speed.

In addition, in the data signal 920, when the clock frequency of the clock signal is low, the eye margin of the clock signal may be widened so that the signal may be stable. Accordingly, high-ratio SSC may be applied to the clock signal. When using the clock signal to which the high-ratio SSC is applied, the system efficiency may be enhanced, reducing power consumption.

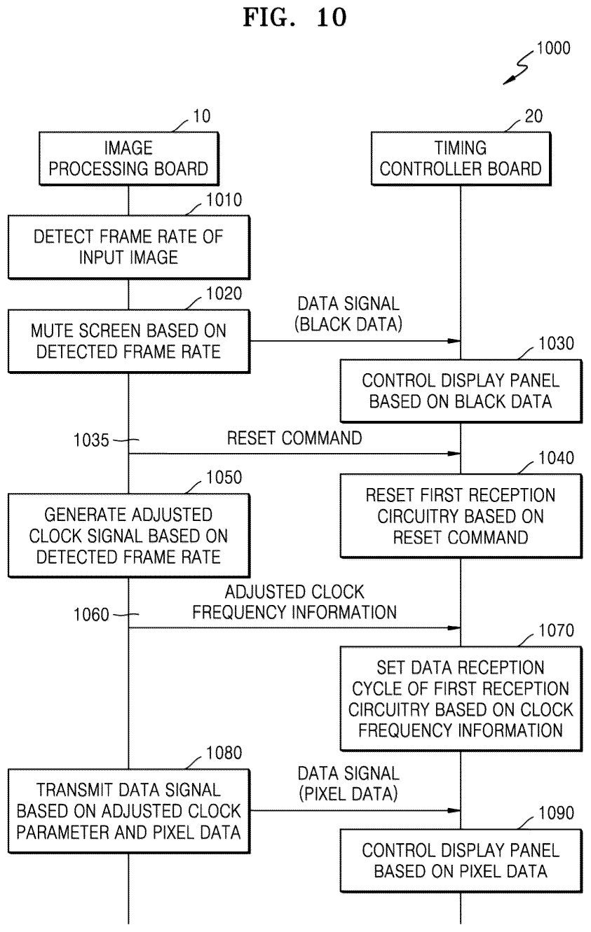

FIG. 10 is a detailed flowchart for describing an operation of generating, by the display apparatus, different clock signals according to a frame rate of content, according to an embodiment of the disclosure. Referring to FIG. 10, a process of operating 1000 the display apparatus 100 may include operations 1010 to 1090. The process of operating 1000 the display apparatus 100 is not limited to that shown in FIG. 10, and any one of the operations shown in FIG. 10 may be omitted, or operations not shown in FIG. 10 may be further included.

At operation 1010, the display apparatus 100 may identify or detect a frame rate of an input image. Operation 1010 may correspond to operation 610 in FIG. 6.

At operation 1020, the display apparatus 100 may perform muting on a display screen based on the identified or detected frame rate. For example, the display apparatus 100 may transmit a data signal corresponding to the muting of the display screen from the image processing board 10 to the timing controller board 20 using the first cable 260. The data signal corresponding to the muting of the display screen may be black data corresponding to RGB data having a value of (0, 0, 0), but is not limited thereto.

At operation 1030, the display apparatus 100 may control the display panel 30 based on the black data.

For example, the display apparatus 100 may identify whether the frame rate has changed. Based on determining that the frame rate has changed, the display apparatus 100 may output a black image. The display apparatus 100 may be in a screen mute state while a clock parameter of a clock signal is adjusted according to the frame rate. Accordingly, noise which occurs on the display screen while the clock parameter (e.g., clock frequency) of the clock signal is adjusted may be minimized.

At operation 1035, the display apparatus 100 may transmit a reset command for the first reception circuitry 310 from the image processing board 10 to the timing controller board 20 using the second cable 270. At operation 1040, the display apparatus 100 may reset the first reception circuitry 310 based on the reset command. When the first reception circuitry 310 is reset, a protocol of the transmission/reception interface may be initialized. For example, a data reception cycle of the first reception circuitry 310 may be reset, and then communication may be newly performed based on the changed clock frequency. For example, if the display panel 30 is outputting a black image while the first reception circuitry 310 is reset, a noise problem may not occur. After being reset, the first reception circuitry 310 may set a data reception cycle based on the new clock frequency, according to operation 1060 described below.

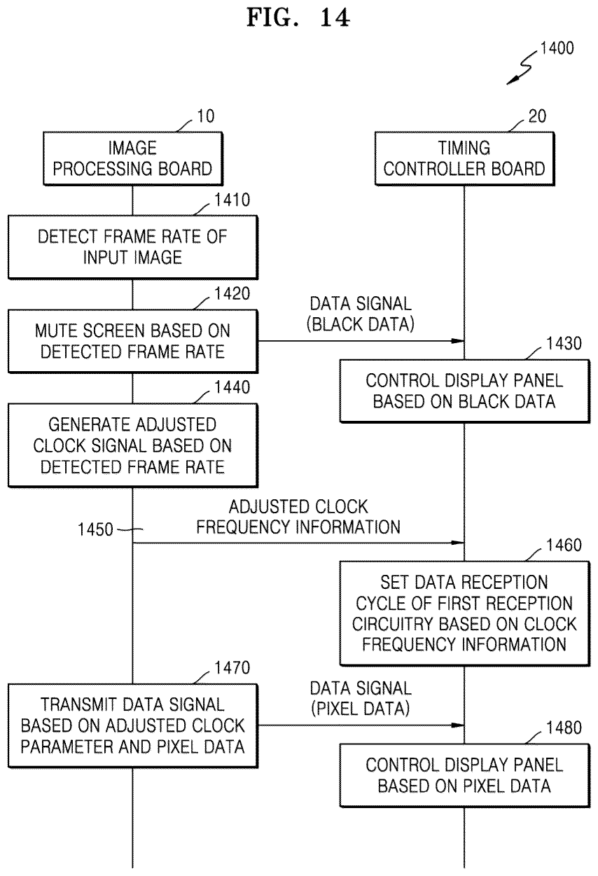

However, in some embodiments, operations 1035 and 1040 may be omitted. An example of this is described with reference to FIG. 14.

At operation 1050, the display apparatus 100 may generate a clock signal with the adjusted clock parameter (e.g., an adjusted clock signal) based on the identified or detected frame rate. Operation 1050 may correspond to operation 620 in FIG. 6.

At operation 1060, the display apparatus 100 may transmit adjusted clock frequency information from the image processing board 10 to the timing controller board 20 using the second cable 270. At operation 1070, the display apparatus 100 may set a data reception cycle of the first reception circuitry 310 based on the adjusted clock frequency information.

For example, the first reception circuitry 310 may preset a data reception cycle according to an increased or reduced clock frequency. Before a data signal corresponding to the adjusted clock frequency is received using the first cable 260, the first reception circuitry 310 may preset the data reception cycle. Accordingly, even when a clock speed of the transmission unit changes, the reception unit may smoothly receive data according to the changed clock speed.

The clock speed of a clock signal, the data transmission cycle of the first transmission circuitry 240, the transmission speed of the first cable 260, and the data reception cycle of the first reception circuitry 310 may correspond to one another. For example, when the clock frequency increases, the first reception circuitry 310 may have a faster data reception cycle. When the clock frequency decreases, the data reception cycle of the first reception circuitry 310 may decrease.

At operation 1080, the display apparatus 100 may transmit a data signal based on the adjusted clock parameter and pixel data, from the image processing board 10 to the timing controller board 20 using the first cable 260. Operation 1080 may correspond to 640 in FIG. 6. The data signal may include pixel data corresponding to the input image. The data signal may have an embedded form in which the clock signal corresponding to the adjusted clock parameter is reflected in the pixel data.

At operation 1090, the display apparatus 100 may control the display panel 30 based on the pixel data.

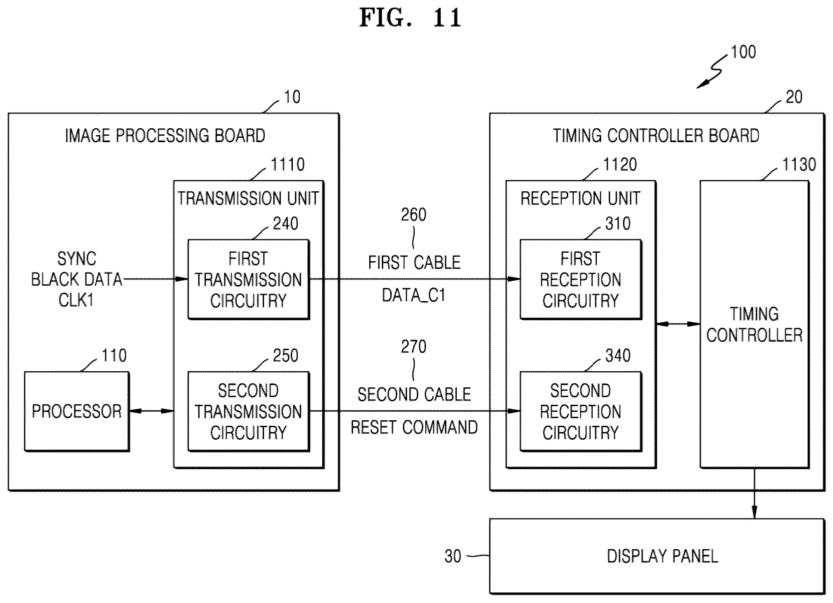

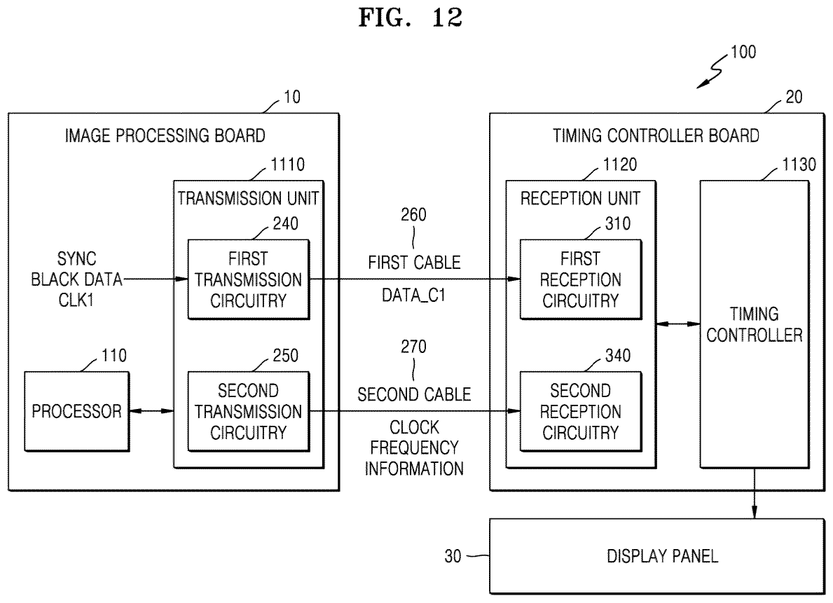

FIG. 11 is an example of an operation of transmitting, by the display apparatus, a signal through the transmission/reception interface, according to an embodiment of the disclosure. FIG. 12 is an example of an operation of transmitting, by the display apparatus, a signal using the transmission/reception interface, according to an embodiment of the disclosure. In the example shown in FIGS. 11 and 12, the first board 200 in FIG. 3 may correspond to the image processing board 10, and the second board 300 in FIG. 3 may correspond to the timing controller board 20. Here, a timing controller 1130 may include the data converter 320 and the clock generator 330 in FIG. 3. The first transmission circuitry 240 and the second transmission circuitry 250 may be referred to as a transmission unit 1110. The first reception circuitry 310 and the second reception circuitry 340 may be referred to as a reception unit 1120.

Examples of 1020, 1030, 1035, and 1040 in FIG. 10 are described in detail with reference to FIG. 11.

At operation 1020, the processor 110 may control the first transmission circuitry 240 to transmit a data signal corresponding to muting of the display screen (e.g., black data) to the first reception circuitry 310 using the first cable 260.

Here, the black data may be converted according to a specification of the first cable 260. For example, the processor 110 may control the first transmission circuitry 240 to generate a data signal DATA_C1, based on a first clock signal CLK1 and the black data. The first clock signal CLK1 may be a clock signal which is adjusted corresponding to a frame rate of the input image before the change. The data signal DATA_C1 may have a form in which the first clock signal CLK1 is embedded in the black data. In the first reception circuitry 310, the data signal DATA_C1 may be restored back to the black data and the first clock signal CLK1. According to an embodiment, the data signal DATA_C1 may also include a synchronization signal Sync.

At operation 1030, the timing controller 1130 provided in the timing controller board 20 may control the display panel 30 based on the received black data. For example, the timing controller 1130 may transmit the black data to the display panel 30. The display panel 30 may output a black image in response to the screen muting.

At operation 1035, the processor 110 may control the second transmission circuitry 250 to transmit a reset command of the first reception circuitry 310 to the second reception circuitry 340 using the second cable 270. At operation 1040, the timing controller 1130 may reset the first reception circuitry 310 based on the reset command of the first reception circuitry 310.

Next, examples of operations 1060, 1070, 1080, and 1090 in FIG. 10 are described in detail with reference to FIG. 12.

At operation 1060, the processor 110 may change the first clock signal CLK1 to a second clock signal CLK2 based on the changed frame rate of the input image. For example, based on determining that the frame rate of the input image has decreased, the clock frequency of the second clock signal CLK2 may be less than the clock frequency of the first clock signal CLK1. The processor 110 may control the second transmission circuitry 250 to transmit frequency information of the second clock signal CLK2 to the second reception circuitry 340 using the second cable 270. At operation 1070, the timing controller 1130 may set the data reception cycle of the first reception circuitry 310 to correspond to the clock frequency of the second clock signal CLK2. As another example, based on determining that the clock frequency of the second clock signal CLK2 has decreased from 95 MHz to 75 MHz, the first reception circuitry 310 may be changed from receiving data 95 million times per second to receiving data 75 million times per second.

At operation 1080, the processor 110 may control the first transmission circuitry 240 to transmit the data signal DATA_C2 based on the adjusted clock parameter and the pixel data, to the first reception circuitry 310 using the first cable 260.

Here, the data signal DATA_C2 may be converted according to the specification of the first cable 260. For example, the processor 110 may control the first transmission circuitry 240 to generate the data signal DATA_C2, based on the second clock signal CLK2 and the pixel data. The data signal DATA_C2 may have a form in which the second clock signal CLK2 is embedded in the pixel data. In the first reception circuitry 310, the data signal DATA_C2 may be restored back to the pixel data and the second clock signal CLK2. According to an embodiment, the data signal DATA_C2 may also include the synchronization signal Sync.

The data signal may include pixel data corresponding to the input image. The data signal may have an embedded form in which the clock signal corresponding to the adjusted clock parameter is reflected in the pixel data.

At operation 1090, the timing controller 1130 may control the display panel 30 based on the received pixel data. The display panel 30 may output the input image with a changed frame rate.

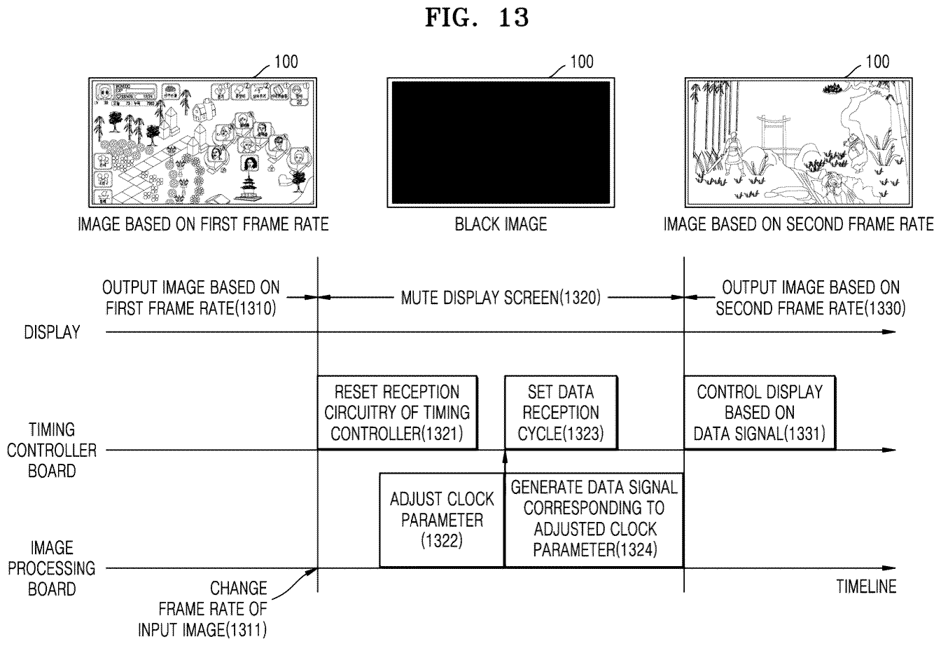

FIG. 13 is a drawing for describing an operation of the display apparatus when an image input to the display apparatus is changed, according to an embodiment of the disclosure.

Referring to FIG. 13, the display apparatus 100 may output an image based on a first frame rate at operation 1310.

The display apparatus 100 may identify that a frame rate of the input image has been changed at operation 1311.

When it is identified that the frame rate of the input image has been changed, the display apparatus 100 may output a black image in response to muting of a display screen at operation 1320.

The display apparatus 100 may reset reception circuitry of a timing controller while the black image is output at operation 1321, adjust a clock parameter of a clock signal used in an image processing board at operation 1322, newly reset a data cycle of the reception circuitry of the timing controller according to the adjusted clock parameter at operation 1323, and generate a data signal corresponding to the adjusted clock parameter and transmit the data signal to a timing controller board at operation 1324.

The timing controller may control a display based on the data signal at operation 1331. The display apparatus 100 may output an image based on a second frame rate at operation 1330.

FIG. 14 is a detailed flowchart for describing an operation of generating, by the display apparatus, different clock signals according to a frame rate of content, according to an embodiment of the disclosure.

A process of operating 1400 the display apparatus 100, of FIG. 14, may include operations 1410 to 1480. According to embodiments, operation 1410 may correspond to operation 1010, operation 1420 may correspond to operation 1020, and operation 1430 may correspond to operation 1030. The process of operating 1400 of FIG. 14 may differ from the process of operating 1000 FIG. 10 in that operations 1035 and 1040 are omitted in FIG. 14. Therefore, operation 1440 may correspond to operation 1050, operation 1450 may correspond to operation 1060, operation 1460 may correspond to operation 1070, operation 1460 may correspond to operation 1070, operation 1470 may correspond to operation 1080, and operation 1480 may correspond to operation 1090.

In the display apparatus 100 according to an embodiment of the disclosure, a reset procedure for the first reception circuitry 310 of the timing controller board 20 may be omitted. Even when the first reception circuitry 310 is not reset, the first reception circuitry 310 may reset a data reception cycle according to a new clock frequency, according to operation 1450 described below.

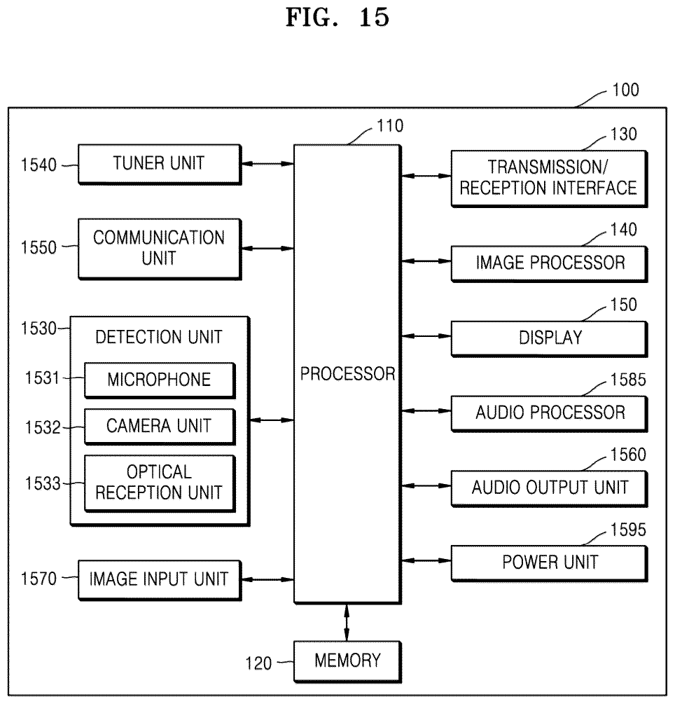

FIG. 15 is a detailed block diagram of the display apparatus according to an embodiment of the disclosure.

Referring to FIG. 15, in addition to the processor 110, the memory 120, the transmission/reception interface 130, the image processor 140, and the display 150, the display apparatus 100 may further include a tuner unit 1540, a communication unit 1550, a detection unit 1530, an image input unit 1570, an audio processor 1585, an audio output unit 1560, the memory 120, and a power unit 1595.

The tuner unit 1540 according to an embodiment of the disclosure may tune and select only a frequency of a channel to be received by the display apparatus 100 from among many radio wave components, by amplifying, mixing, or resonating a broadcast signal received using a cable or wirelessly. The broadcast signal may include audio, video, and additional information (e.g., an EPG).

The tuner unit 1540 may receive a broadcast signal from various sources, such as terrestrial broadcasting, cable broadcasting, satellite broadcasting, or Internet broadcasting. The tuner unit 1540 may receive a broadcast signal from a source such as analog broadcasting or digital broadcasting.

The communication unit 1550 may transmit and receive data or signals to and from an external device or server. For example, the communication unit 1550 may include a Wi-Fi module, a Bluetooth module, an infrared communication module, a wireless communication module, a local area network (LAN) module, an Ethernet module, a wired communication module, or the like. For example, each of the communication modules may be implemented in the form of at least one hardware chip.

The Wi-Fi module and the Bluetooth module may perform communication by using a Wi-Fi process and a Bluetooth process, respectively. When the Wi-Fi module or the Bluetooth module is used, various connection information, such as service set identifier (SSID) or a session key, may be transmitted and received first, communicative connection may be performed by using the connection information, and then various information may be transmitted and received. A wireless communication module may include at least one communication chip configured to perform communication according to various wireless communication specifications, such as Zigbee, 3rd Generation (3G), 3rd Generation Partnership Project (3GPP), Long Term Evolution (LTE), LTE Advanced (LTE-A), 4th Generation (4G), or 5th Generation (5G).

The detection unit 1530 according to an embodiment of the disclosure may detect a speech, image, or interaction of a user, and may include a microphone 1531, a camera unit 1532, and an optical reception unit 1533.

The microphone 1531 may receive a user's uttered speech. The microphone 1531 may convert the received speech into an electric signal and output the electric signal to the processor 110.

The optical reception unit 1533 may receive an optical signal (including a control signal) received from an external control device through an optical window in a bezel of the display 150. The optical reception unit 1533 may receive an optical signal corresponding to a user input (e.g., touch, press, touch gesture, speech, or motion) from the control device. Under the control by the processor 110, a control signal may be extracted from the received optical signal.

The image input unit 1570 according to an embodiment of the disclosure may receive video (e.g., moving image or the like), audio (e.g., speech, music, or the like), and additional information (e.g., EPG or the like) from the outside. An input/output unit 1270 may include any one of HDMI, MHL, USB, DP, Thunderbolt, VGA port, RGB port, D-SUB, DVI, component jack, or PC port. The image input unit 1570 may correspond to the image input unit 210 in FIG. 3.

The processor 110 may include at least one of a central processing unit (CPU), a graphics processing unit (GPU), and a video processing unit (VPU). In some embodiments, depending on the embodiment of the disclosure, the processor 110 may be implemented in the form of an SoC integrating at least one of a CPU, a GPU, or a VPU. In some embodiments, the processor 110 may further include a neural processing unit (NPU).

The memory 120 may store various data, programs, or applications for driving and controlling the display apparatus 100. In addition, the programs stored in the memory 120 may include one or more instructions. The programs (one or more instructions) or applications stored in the memory 120 may be executed by the processor 110.

The processor 110 according to an embodiment of the disclosure may execute the one or more instructions stored in the memory 120 to obtain an image. The image may be an image prestored in the memory 120 or may be an image received from an external device using the tuner unit 1540 or the communication unit 1550. In addition, the image may be an image on which various image processing, such as decoding, scaling, noise reduction, frame rate conversion, or resolution conversion, has been performed.

The display 150 according to an embodiment of the disclosure may generate a driving signal by converting an image signal, data signal, on-screen display (OSD) signal, control signal, or the like processed by the processor 110. The display 150 may be configured as a touchscreen and used as an input device in addition to an output device.

The audio processor 1585 may process audio data. The audio processor 1585 may perform various processing, such as decoding, amplification, or noise reduction, on audio data. The audio processor 1585 may include a plurality of audio processing module for processing audio corresponding to a plurality of items of content.

Under the control by the processor 110, the audio output unit 1560 may output audio included in a broadcast signal received using the tuner unit 1540. The audio output unit 1560 may output audio (e.g., speech or sound) input using the communication unit 1550 or the image input unit 1570. In addition, under the control by the processor 110, the audio output unit 1560 may output audio stored in the memory 120. The audio output unit 1560 may include at least one of a speaker, a headphone output terminal, or a Sony/Philips Digital Interface (S/PDIF) output terminal.

Under the control by the processor 110, the power unit 1595 may supply power input from an external power source to internal elements of the display apparatus 100. In addition, under the control by the processor 110, the power unit 1595 may supply, to the internal elements, power output from at least one battery located inside the display apparatus 100.

In some embodiments, the memory 120 may include a broadcast reception module, a channel control module, a volume control module, a communication control module, a speech recognition module, a motion recognition module, an optical reception module, a display control module, an audio control module, an external input control module, a power control module, a power control module of an external device connected wirelessly (e.g., using Bluetooth), speech database (DB), or motion DB. By using these software stored in the memory, the processor 110 may perform respective functions.

The display apparatus according to an embodiment of the disclosure includes transmission circuitry, reception circuitry, a transmission/reception interface connecting the reception circuitry and the transmission circuitry, memory storing one or more instructions, and at least one processor configured to execute the one or more instructions stored in the memory.

According to an embodiment of the disclosure, the instructions, when executed by the at least one processor, individually or collectively, cause the display apparatus to detect a frame rate of an input image.

According to an embodiment of the disclosure, the instructions, when executed by the at least one processor, individually or collectively, cause the display apparatus to adjust a clock parameter of a clock signal based on the detected frame rate to generate an adjusted clock signal.

According to an embodiment of the disclosure, the instructions, when executed by the at least one processor, individually or collectively, cause the display apparatus to transmit a data signal generated based on the adjusted clock signal and image data corresponding to the input image, from the transmission circuitry to the reception circuitry using the transmission/reception interface.

The transmission circuitry according to an embodiment of the disclosure may be included in an image processing board including the at least one processor and the reception circuitry may be included in a timing controller board.

According to an embodiment of the disclosure, the instructions, when executed by the at least one processor, individually or collectively, may cause the display apparatus to convert the clock signal and the image data into the data signal such that the clock signal and the image data comply with a specification of the transmission/reception interface.

The specification of the transmission/reception interface according to an embodiment of the disclosure may comprises a V-by-One specification, and within the data signal, the clock signal is included in the image data.

The clock parameter according to an embodiment of the disclosure may include at least one of a clock frequency, voltage strength, or SSC ratio of the clock signal.

According to an embodiment of the disclosure, the instructions, when executed by the at least one processor, individually or collectively, may cause the display apparatus to generate the adjusted clock signal by setting a clock frequency of the clock signal to an adjusted clock frequency. The adjusted clock frequency is set to a first clock frequency based on the frame rate being a first frame rate. The adjusted clock frequency is set to a second clock frequency higher than the first clock frequency based on the frame rate being a second frame rate higher than the first frame rate. A data transmission speed of the data signal is adjusted based on the adjusted clock frequency.

According to an embodiment of the disclosure, the instructions, when executed by the at least one processor, individually or collectively, may cause the display apparatus to generate the adjusted clock signal by setting a voltage strength of the clock signal to an adjusted voltage strength. The adjusted voltage strength is set to a first voltage strength based on the frame rate being the first frame rate. The adjusted voltage strength is set to a second voltage strength higher than the first voltage strength based on the frame rate being the second frame rate. According to an embodiment of the disclosure, the instructions, when executed by the at least one processor, individually or collectively, may cause the display apparatus to based on the frame rate being the first frame rate, generate the adjusted clock signal by applying a first spread spectrum clock (SSC) ratio and based on the frame rate being the second frame rate, generate the adjusted clock signal by applying at least one of a second SSC ratio lower than the first SSC ratio, or an SSC ratio of zero (“0”) (e.g., a clock signal having no SSC ratio, or a clock signal having an SSC ratio of zero (“0”)).

According to an embodiment of the disclosure, the instructions, when executed by the at least one processor, individually or collectively, may cause the display apparatus to based on detecting a change in the frame rate of the input image, transmit image data corresponding to a muting of a display screen from the transmission circuitry to the reception circuitry using the transmission/reception interface. The clock parameter of the clock signal is adjusted while the display screen is in a mute state.

According to an embodiment of the disclosure, the display apparatus further comprises a cable that connects a first board to a second board. The cable is different from the transmission/reception interface. The first board comprises the transmission circuitry and the second board comprises the reception circuitry. According to an embodiment of the disclosure, the instructions, when executed by the at least one processor, individually or collectively, may cause the display apparatus to generate the adjusted clock signal based on the detected frame rate and transmit information about the adjusted clock frequency from the first board to the second board using the cable. The second board is configured to set a data reception cycle of the reception circuitry based on the information about the adjusted clock frequency received using the cable and receive the data signal corresponding to the adjusted clock frequency using the transmission/reception interface based on the data reception cycle of the reception circuitry being set.

According to an embodiment of the disclosure, the instructions, when executed by the at least one processor, individually or collectively, may cause the display apparatus to based on detecting a change in the frame rate of the input image, transmit a reset command for resetting the reception circuitry from the first board to the second board using the cable, wherein the data reception cycle of the reception circuitry is reset based on the reset command.

A process of operating a display apparatus, according to an embodiment of the disclosure, the display apparatus including transmission circuitry, reception circuitry, and a transmission/reception interface connecting the transmission circuitry and the reception circuitry includes detecting a frame rate of an input image, adjusting a clock parameter of a clock signal based on the detected frame rate to generate an adjusted clock signal and transmitting a data signal generated based on the adjusted clock signal and image data corresponding to the input image, from the transmission circuitry to the reception circuitry using the transmission/reception interface.

The process of operating a display apparatus, according to an embodiment of the disclosure, may further include converting the adjusted clock signal and the image data into the data signal such that the clock signal and the image data comply with a specification of the transmission/reception interface. The specification of the transmission/reception interface according to an embodiment of the disclosure may comprises a V-by-One specification, and wherein, within the data signal, the clock signal is included in the image data . . .

The adjusting of the clock parameter of the clock signal based on the detected frame rate, according to an embodiment of the disclosure, may comprises setting a clock frequency of the clock signal to an adjusted clock frequency, wherein the adjusted clock frequency is set to a first clock frequency based on the frame rate being a first frame rate, wherein the adjusted clock frequency is set to a second clock frequency higher than the first clock frequency based on the frame rate being a second frame rate higher than the first frame rate, and wherein a data transmission speed of the data signal is adjusted based on the adjusted clock frequency.

The adjusting of the clock parameter of the clock signal based on the detected frame rate, according to an embodiment of the disclosure, may comprises setting a voltage strength of the clock signal to an adjusted voltage strength, wherein the adjusted voltage strength is set to a first voltage strength based on the frame rate being the first frame rate and wherein the adjusted voltage strength is set to a second voltage strength higher than the first voltage strength based on the frame rate being the second frame rate.

The adjusting of the clock parameter of the clock signal based on the detected frame rate, according to an embodiment of the disclosure, may comprises generating the adjusted clock signal by applying a first spread spectrum clock (SSC) ratio is applied based on the frame rate being the first frame rate and based on the frame rate being the second frame rate, generating the adjusted clock signal by applying at least one of a second SSC ratio lower than the first SSC ratio, or an SSC ratio of zero (“0”).

The process of operating a display apparatus, according to an embodiment of the disclosure, may further include based on identifying a change in the frame rate of the input image, transmitting image data corresponding to a muting of a display screen from the transmission circuitry to the reception circuitry using the transmission/reception interface, wherein the clock parameter of the clock signal is adjusted while the display screen is in a mute state.

According to an embodiment of the disclosure, the adjusted clock signal is generated by setting a clock frequency of the clock signal to an adjusted clock frequency based on the detected frame rate. The process of operating a display apparatus, according to an embodiment of the disclosure, may further include transmitting information about the adjusted clock frequency from a first board to a second board using a cable that connects the first board to the second board, wherein the cable is different from the transmission/reception interface, and wherein the first board comprises the transmission circuitry and the second board comprises the reception circuitry, setting a data reception cycle of the reception circuitry based on the information about the adjusted clock frequency received using the cable and receiving the data signal corresponding to the adjusted clock frequency using the transmission/reception interface based on the data reception cycle of the reception circuitry being set.

According to an embodiment of the disclosure, provided may be a computer-readable recording medium on which a program for performing the process of operating a display apparatus, on a computer, is recorded.

A machine-readable storage medium may be provided in the form of a non-transitory storage medium. Here, the “non-transitory storage medium” only denotes a tangible device that does not include a signal (e.g., electromagnetic waves), and the term does not distinguish a case where data semi-permanently stored in a storage medium from a case where data is temporarily stored in a storage medium. For example, the “non-transitory storage medium” may include a buffer where data is temporarily stored.

According to an embodiment of the disclosure, the process according to an embodiment of the disclosure may be provided by being included in a computer program product. The computer program product may be traded between sellers and buyers. The computer program product may be distributed in the form of a machine-readable storage medium (e.g., a compact disc read-only memory (CD-ROM)), or may be distributed (e.g., downloaded or uploaded) online through an application store or directly between two user devices (e.g., smartphones). In the case of online distribution, at least a portion of the computer program product (e.g., a downloadable application) may be at least temporarily generated or temporarily stored in a machine-readable storage medium, such as a server of a manufacturer, a server of an application store, or a memory of a relay server.

What is claimed is:

1. A display apparatus comprising:
transmission circuitry;
reception circuitry;
a transmission/reception interface configured to connect the reception circuitry to the transmission circuitry;
at least one processor; and
memory configured to store instructions which, when executed by the at least one processor, individually or collectively, cause the display apparatus to:
detect a frame rate of an input image;
adjust a clock parameter of a clock signal based on the detected frame rate to generate an adjusted clock signal; and
transmit a data signal generated based on the adjusted clock signal and image data corresponding to the input image, from the transmission circuitry to the reception circuitry using the transmission/reception interface.

2. The display apparatus of claim 1, wherein the transmission circuitry is included in an image processing board comprising the at least one processor, and
wherein the reception circuitry is included in a timing controller board.

3. The display apparatus of claim 1, wherein the instructions, when executed by the at least one processor, individually or collectively, further cause the display apparatus to:
convert the clock signal and the image data into the data signal such that the clock signal and the image data comply with a specification of the transmission/reception interface.

4. The display apparatus of claim 3, wherein the specification comprises a V-by-One specification, and
wherein, within the data signal, the clock signal is included in the image data.

5. The display apparatus of claim 1, wherein the clock parameter comprises at least one of a clock frequency, a voltage strength, or a spread spectrum clock (SSC) ratio of the clock signal.

6. The display apparatus of any claim 1,
wherein the instructions, when executed by the at least one processor, individually or collectively, further cause the display apparatus to generate the adjusted clock signal by setting a clock frequency of the clock signal to an adjusted clock frequency,
wherein, the adjusted clock frequency is set to a first clock frequency based on the frame rate being a first frame rate; and
wherein the adjusted clock frequency is set to a second clock frequency higher than the first clock frequency based on the frame rate being a second frame rate higher than the first frame rate, and
wherein a data transmission speed of the data signal is adjusted based on the adjusted clock frequency.

7. The display apparatus of claim 6, wherein the instructions, when executed by the at least one processor, individually or collectively, further cause the display apparatus to generate the adjusted clock signal by setting a voltage strength of the clock signal to an adjusted voltage strength,
wherein the adjusted voltage strength is set to a first voltage strength based on the frame rate being the first frame rate; and
wherein the adjusted voltage strength is set to a second voltage strength higher than the first voltage strength based on the frame rate being the second frame rate.

8. The display apparatus of claim 6, wherein the instructions, when executed by the at least one processor, individually or collectively, further cause the display apparatus to:
based on the frame rate being the first frame rate, generate the adjusted clock signal by applying a first spread spectrum clock (SSC) ratio; and
based on the frame rate being the second frame rate, generate the adjusted clock signal by applying at least one of a second SSC ratio lower than the first SSC ratio, or an SSC ratio of zero (“0”).

9. The display apparatus of claim 1, wherein the instructions, when executed by the at least one processor, individually or collectively, further cause the display apparatus to:
based on detecting a change in the frame rate of the input image, transmit image data corresponding to a muting of a display screen from the transmission circuitry to the reception circuitry using the transmission/reception interface,
wherein the clock parameter of the clock signal is adjusted while the display screen is in a mute state.

10. The display apparatus of claim 6, wherein the display apparatus further comprises a cable that connects a first board to a second board, wherein the cable is different from the transmission/reception interface, and wherein the first board comprises the transmission circuitry and the second board comprises the reception circuitry,
wherein the instructions, when executed by the at least one processor, individually or collectively, further cause the display apparatus to:
generate the adjusted clock signal based on the detected frame rate; and
transmit information about the adjusted clock frequency from the first board to the second board using the cable, and
wherein the second board is configured to:
set a data reception cycle of the reception circuitry based on the information about the adjusted clock frequency received using the cable; and
receive the data signal corresponding to the adjusted clock frequency using the transmission/reception interface based on the data reception cycle of the reception circuitry being set.

11. The display apparatus of claim 10, wherein the instructions, when executed by the at least one processor, individually or collectively, further cause the display apparatus to:
based on detecting a change in the frame rate of the input image, transmit a reset command for resetting the reception circuitry from the first board to the second board using the cable,
wherein the data reception cycle of the reception circuitry is reset based on the reset command.

12. A method of operating a display apparatus including transmission circuitry, reception circuitry, and a transmission/reception interface configured to connect the transmission circuitry to the reception circuitry, the method comprising:
detecting a frame rate of an input image;
adjusting a clock parameter of a clock signal based on the detected frame rate to generate an adjusted clock signal; and
transmitting a data signal generated based on the adjusted clock signal and image data corresponding to the input image, from the transmission circuitry to the reception circuitry using the transmission/reception interface.

13. The method of claim 12, further comprising converting the adjusted clock signal and the image data into the data signal such that the clock signal and the image data comply with a specification of the transmission/reception interface.

14. The method of claim 13, wherein the specification comprises a V-by-One specification, and
wherein, within the data signal, the clock signal is included in the image data.

15. The method of claim 12, wherein the adjusting of the clock parameter comprises setting a clock frequency of the clock signal to an adjusted clock frequency,
wherein the adjusted clock frequency is set to a first clock frequency based on the frame rate being a first frame rate,
wherein the adjusted clock frequency is set to a second clock frequency higher than the first clock frequency based on the frame rate being a second frame rate higher than the first frame rate, and
wherein a data transmission speed of the data signal is adjusted based on the adjusted clock frequency.

16. The method of claim 15, wherein the adjusting of the clock parameter comprises setting a voltage strength of the clock signal to an adjusted voltage strength,
wherein the adjusted voltage strength is set to a first voltage strength based on the frame rate being the first frame rate; and
wherein the adjusted voltage strength is set to a second voltage strength higher than the first voltage strength based on the frame rate being the second frame rate.

17. The method of claim 15, wherein the adjusting comprises:
generating the adjusted clock signal by applying a first spread spectrum clock (SSC) ratio is applied based on the frame rate being the first frame rate; and
based on the frame rate being the second frame rate, generating the adjusted clock signal by applying at least one of a second SSC ratio lower than the first SSC ratio, or an SSC ratio of zero (“0”).

18. The method of claim 12, further comprising, based on identifying a change in the frame rate of the input image, transmitting image data corresponding to a muting of a display screen from the transmission circuitry to the reception circuitry using the transmission/reception interface,
wherein the clock parameter of the clock signal is adjusted while the display screen is in a mute state.

19. The method of claim 12, wherein the adjusted clock signal is generated by setting a clock frequency of the clock signal to an adjusted clock frequency based on the detected frame rate, and
wherein the method further comprises:
transmitting information about the adjusted clock frequency from a first board to a second board using a cable that connects the first board to the second board, wherein the cable is different from the transmission/reception interface, and wherein the first board comprises the transmission circuitry and the second board comprises the reception circuitry;
setting a data reception cycle of the reception circuitry based on the information about the adjusted clock frequency received using the cable; and
receiving the data signal corresponding to the adjusted clock frequency using the transmission/reception interface based on the data reception cycle of the reception circuitry being set.

20. A non-transitory computer-readable recording medium having recorded thereon instructions which, when executed by at least one processor of an electronic device, individually or collectively, cause the electronic device to:
detect a frame rate of an input image;
adjust a clock parameter of a clock signal based on the detected frame rate to generate an adjusted clock signal; and
transmit a data signal generated based on the adjusted clock signal and image data corresponding to the input image, from transmission circuitry included in the electronic device to reception circuitry included in the electronic device using a transmission/reception interface included in the electronic device.
